(19) United States
(12) Patent Application Publication
(10) Pub. No.: US 2013/0330122 A1
(43) Pub. Date: Dec. 12, 2013

(54) CANTED COIL SPRINGS WITH CONTOURED WIRE SHAPES, RELATED SYSTEMS, AND RELATED METHODS

(71) Applicant: BAL SEAL ENGINEERING, INC., Foothill Ranch, CA (US)

(72) Inventors: Majid Ghasiri, Foothill Ranch, CA (US); Peter J. Balsells, Foothill Ranch, CA (US)

(21) Appl. No.: 13/908,525

(22) Filed: Jun. 3, 2013

Related U.S. Application Data
(60) Provisional application No. 61/658,832, filed on Jun. 12, 2012.

(51) Int. Cl. F16F 1/04; B21F 35/00; F16B 17/00

(52) U.S. Cl. CPC F16F 1/045; F16F 1/042; F16B 17/00; B21F 35/00
USPC 403/327; 267/180; 140/103

(57) ABSTRACT

Canted coil springs are disclosed wherein wires used to form the springs have sections with shapes that are not generally round. The different shapes are configured to increase contact surface areas by providing more surface-to-surface contacts with adjacent surfaces of a housing and a shaft over a single point contact typically found with round wires. The disclosed springs may be used with a housing and a shaft in a holding application, a latching application, a locking application, or combinations thereof.

### FIELD OF ART

The present application generally relates to canted coil springs, and more particularly, to methods, devices, and systems related to canted coil springs having contoured wire shapes, applications of said springs, and methods for forming and using said springs.

### BACKGROUND

Conventional canted coil springs have tangential points of contact between some of the coils if not all of the coils and one or more flat surfaces of a groove in which the spring is partly or fully received. The noted tangential points of contact are formed by the elliptical coils of the spring contacting the one or more flat surfaces of the groove. Because contact between the coils and the groove occurs at one or more points, a limited total contact surface area, which is the sum of the individual contact points, is available for thermal and/or electrical conductivity.

Canted coil springs may be used to electrically connect two parts. The same canted coil springs may also be used as mechanical connectors without utilizing the springs' conductivity characteristics. One of the two parts is typically a female part having a bore that that receives the second part, which is typically a male part. The male part may be shaped similar to a pin, shaft, plug, shank or the like and may have an outer surface with a shape corresponding to the shape of the bore. The outer diameter of the pin is smaller than the inner diameter of the bore to allow insertion of the pin into the bore and removal of the pin from the bore. The inner surface of the bore includes a groove for retaining a canted coil spring, which may instead be located on the pin and the combination with the spring configured to be inserted into the bore. In conventional current conducting applications using canted coil springs, the pin is inserted into the bore of the female part such that the outer surface of the pin contacts the canted coil spring, which is located in the bore. The canted coil spring establishes a connection between the outer surface of the pin and the inner surface of the bore.

### SUMMARY

A method for manufacturing a spring is disclosed. The method comprising obtaining a wire that has at least a wire section with a different shape than a generally round shape; and coiling the wire to form a plurality of interconnected coils with each coil canting in a same direction relative to a coil axis.

The method wherein the wire has been drawn through a die to have the different shape. The method wherein the different shape is a round shape with a flat section, a round shape with a partially flatted section, an elliptical shape, a multi-point star shape, a hexagonal shape with round corners and rounded sides, a hexagonal shape with rounded corners, or combinations thereof.

The method wherein the spring is an axial canted coil spring or a radial canted coil spring.

The method wherein the different shape is located on a first side edge and a second side edge of the spring.

The method wherein the wire has the different shape along an entire length of the wire.

The method further comprising placing the spring into a groove comprising two sidewalls and a bottom wall and wherein the different shape contacts the sidewalls or the bottom wall.

The method wherein the bottom wall is V-shape. The method wherein the groove is located in a bore of a housing or an outside surface of a shaft.

A connector is disclosed. In one example, the connector comprising a housing and a shaft, a groove associated with the housing, the shaft, or both and having a canted coil spring disposed therein, wherein the spring comprises at least a wire section with a different shape than a generally round shape at locations of the spring that contact the housing, the shaft, or both the housing and the shaft. The spring can be a radial canted coil spring or an axial canted coil spring. Each spring comprises a plurality of coils with each coil having a major axis and a minor axis. The spring is understood to cant along the minor axis of the coils.

The connector wherein the wire section with the different shape is a round shape with a flat section, a round shape with a partially flatted section, an elliptical shape, a multi-point star shape, a hexagonal shape with round corners and rounded sides, a hexagonal shape with rounded corners, or combinations thereof.

The connector wherein the groove is located in a bore of the housing.

The connector wherein the wire for forming the spring is made entirely from the different shape.

The connector wherein the groove is located on an outside of the shaft.

The connector wherein spring is made from a multi-metallic wire.

The connector wherein the groove is associated with both the housing and the shaft and the connector of a latching connector or a locking connector.

The connector wherein the groove has a flat bottom or a V-bottom groove.

A canted coil spring comprising a plurality of coils all canted along a same direction and wherein the spring is made from a wire having at least a wire section with a different shape than a generally round shape.

The canted coil spring wherein the spring is a garter-type radial canted coil spring or axial canted coil spring.

The canted coil spring wherein with the different shape is a round shape with a flat section, a round shape with a partially flatted section, an elliptical shape, a multi-point star shape, a hexagonal shape with round corners and rounded sides, a hexagonal shape with rounded corners, or combinations thereof.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a partial side view of a prior art canted coil spring.

FIG. 2 is a partial side view of a canted coil spring provided in accordance with aspects of the present device, system, and method.

FIGS. 2A-2F are cross-sectional end views of different shaped wires that are useable in forming or manufacturing the spring of FIG. 2.

FIG. 3 is a partial cross-sectional side view of a connector comprising a housing and a shaft with a spring located in a groove.

FIGS. 3A-3F are cross-sectional end views of various shaped wires useable in forming the spring of FIG. 3, taken along lines A-A, B-B, and C-C.

FIG. 4 is a partial cross-sectional side view of a connector comprising a housing and a shaft with a spring located in a groove.

FIGS. 4A-4F are cross-sectional end views of various shaped wires useable in forming the spring of FIG. 4, taken along lines A-A, B-B, and C-C.

FIG. 5 is a partial cross-sectional side view of a connector comprising a housing and a shaft with a spring located in a groove.

FIGS. 5A-5F are cross-sectional end views of various shaped wires useable in forming the spring of FIG. 5, taken along lines A-A, B-B, and C-C.

FIG. 6 is a partial cross-sectional side view of a connector comprising a housing and a shaft with a spring located in a groove.

FIGS. 6A-6F are cross-sectional end views of various shaped wires useable in forming the spring of FIG. 6, taken along lines A-A, B-B, and C-C.

FIG. 7 is a schematic process flow diagram depicting a method for forming a canted coil spring having a shaped wire section or sections and method for making and using a connector with the spring having the shaped wired section or sections.

### DETAILED DESCRIPTION

The detailed description set forth below in connection with the appended drawings is intended as a description of the presently preferred embodiments of canted coil springs provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

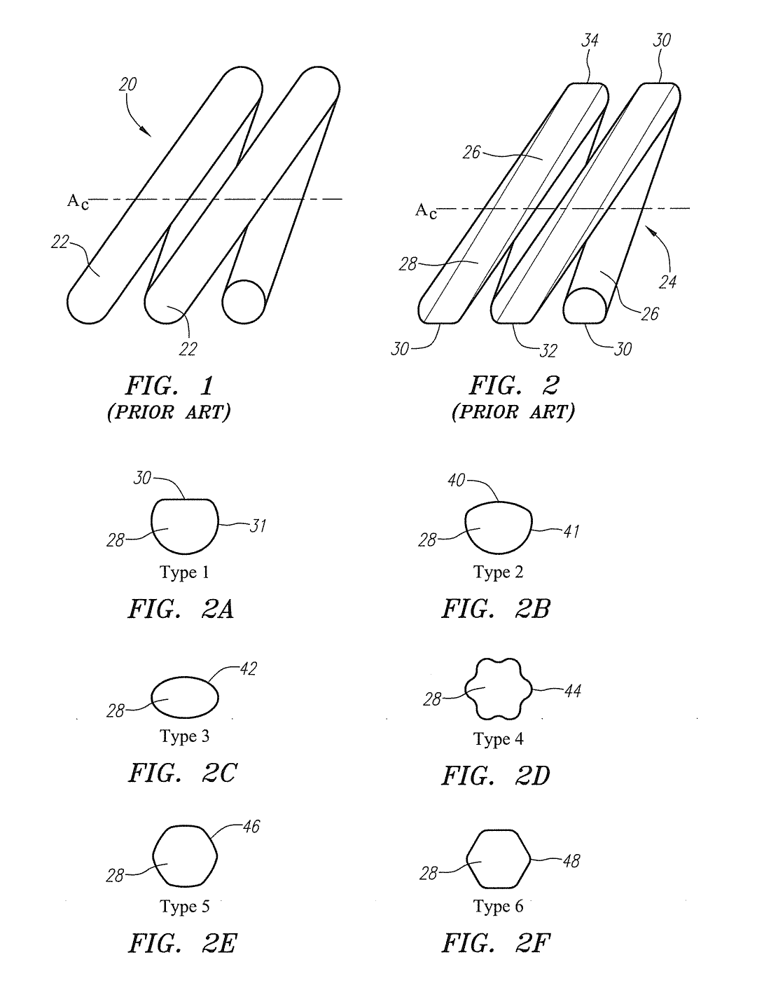

FIG. 1 is a partial side or elevation view of a prior art canted coil spring 20 comprising a plurality of interconnected coils 22 all canted or slanted at an acute angle relative to the coil axis A_{c}. The coils 22 typically each comprises a coil width or major axis and a coil height or minor axis, which is smaller in dimension than the major axis. When compressed along their minor axes, the coils further cant from their respective original canted position to a further canting angle. The spring 20 has a generally constant force versus deflection curve along a working range of deflection when the coils are canted. The spring may be made from a stainless steel or other high tensile strength material. For electrically conductive applications, the spring may be made from copper, copper alloy, brass, or brass alloy. Additional information regarding canted coil springs are disclosed in U.S. Pat. Nos. 4,655,462; 4,826,144; 4,876,781; 4,907,788; 4,915,366; 4,961,253; 4,964,204; 5,139,243; 5,160,122; 5,503,375; and 5,615,870, the contents of each of which are expressly incorporated herein by reference.

With reference now to FIG. 2, a partial side or elevation view of a canted coil spring 24 provided in accordance with aspects of the present devices, systems, and methods is shown, which comprises a plurality of coils 26 all canted at an acute angle relative to a coil axis A_{c}. The coil spring or spring 24 may embody a length of coils 26 having two ends or can be a garter-type spring with the two ends connected to one another. The ends may be welded or simply interconnected using varying end coil sizes to create a mechanical engagement without welding. The coils 26 may all have approximately the same size or can vary in dimensions as disclosed in co-pending application Ser. No. 13/453,337, filed Apr. 23, 2012, entitled SPRING CONTACTS, the contents of which are expressly incorporated herein by reference.

In one example, the canted coil spring 24 is coiled from a wire 28 having a truncated circular cross-section or a flattened round wire cross-section, which has a generally planar or flat wire section 30. For example, a wire may be extruded through a die having a corresponding flat section so that a wire 28 having a flat cross-section 30 may be formed, as shown. The wire 28 with the flat section 30 may then be used to form or roll a canted coil spring 24. The wire may be made from a number of metallic materials, such as a conductive material like as copper, copper alloy, Beryllium-copper, or from a high tensile strength metallic material, such as stainless steel, SS. In another embodiment, the wire has a base metal and one or more outer cladding or coating metallic layers each from a different metallic material. For example, the wire can have a SS based material with a copper outer cladding. In another example, the copper is the base material and SS is used for cladding.

With reference again to FIG. 2, when the wire 28 is coiled or rolled into a canted coil spring, the flat section 30 of the wire is caused to be disposed on a first cross-sectional side edge 32 and a second cross-sectional side edge 34 to form flat sections 30 that can abut a housing and a pin with line contacts as opposed to single point contacts. For example, the first cross-sectional side edge 32 can form the inside diameter of the garter-type canted coil spring 24 and contacts a pin while the second cross-sectional side edge 34 can form the outside diameter of the garter-type canted coil spring and contacts a housing. The line contacts between the individual coils 26 and the connector components provide added stability over point contacts and increase the contact surface areas between the coils and the connector components, such as a pin and a housing. As discussed in co-pending application publication No. 2011/0062640, and in co-pending application Ser. No. 13/315,759, filed Dec. 9, 2011, entitled ELECTRICAL CONNECTOR WITH A CANTED COIL SPRING, the contents of which are expressly incorporated herein by reference, increasing contact areas can decrease heat build-up and improve electrical transmissions between a pin and a housing of an electrical connector having a canted coil spring disposed therebetween. In the present disclosure, the contact surface areas are increased by modifying a wire cross-section from round and subsequently use to roll or coil into a canted coil spring 24 having flat sections along a first cross-sectional side edge 32 and a second cross-sectional side edge 34. Conceivably, the wire can be round and rolled or coiled into a canted coil spring and post-coiled processed to form flat sections for use with the assemblies and methods of the present disclosure.

Thus, aspects of the present disclosure is understood to include a canted coil spring made from a metallic wire and having a plurality of coils that are canted along a same canting direction and wherein the wire has a first contour and a second contour along a cross-section of the wire that differs from the first contour. In one example, the first contour is generally round and the second contour is generally flat. In a particular example, the canted coil spring is an inside contact section and an outside contact section and wherein the generally flat contour is positioned at least along both the inside contact section and the outside contact section. In other examples, the first contour and the second contour can embody other shapes.

FIG. 2A is a cross-sectional end view of the wire 28 of FIG. 2, which more clearly shows the flat section 30 of the wire and the round section 31 of the wire. The round section or contour 31 may be understood to be the first contour and the flat section or contour 30 may be understood to be the second contour. Further, as used herein, the terms first and second are meant to distinguish one element or structure from another element or structure only and not necessarily to limit the scope of the terms unless the context indicates otherwise.

FIG. 2B is an alternative embodiment wherein the wire 28 has a more curved, rounded, or partially flattened section or second contour 40 and a more generally round or first contour 41. The partially flattened section 40 provides a greater contact surface area than a single point contact of a round wire when the shaped wire 28 is formed into a canted coil spring and the partially flattened section 40 positioned as first cross-sectional side edge 32 and second cross-sectional side edge 34 of the spring to contact a pin and a housing.

FIG. 2C is an alternative embodiment wherein the wire 28 has an elliptical 42 configuration. The curved surface of the elliptical wire provides a greater contact surface area than a single point contact of a round wire. Thus, while the wire 28 of FIG. 2C also has a first contour section and a second contour section, the two contour cross-sections are the same so that a canted coil spring formed by the wire of FIG. 2C can have either contour section being positioned as first cross-sectional side edge 32 and second cross-sectional side edge 34 of the spring.

FIG. 2D is an alternative embodiment wherein the wire 28 has a six-pointed star shape 44 cross-section. In other embodiment, the star shape can have fewer or more than six points. The star shape wire 28 provides at least two contact points with the housing and/or the shaft when the six-pointed star shape is coiled or rolled into a canted coil spring, which is more than a typical single point contact of a round wire.

FIG. 2E is an alternative embodiment wherein the wire 28 has a hexagonal shape 46 with rounded corners between the sides and with the flat surfaces of a typical hexagon slightly rounded, similar to the embodiment of FIG. 2b. The hexagonal shape wire when coiled or rolled into a canted coil spring provides a greater contact surface area with the housing and/or the shaft than a single point contact of a round wire.

FIG. 2F is an alternative embodiment wherein the wire 28 has a hexagonal shape 46 with rounded corners and flat surfaces in between each rounded corners. The hexagonal shape wire when coiled or rolled into a canted coil spring provides a greater contact surface area with the housing and/or the shaft than a single point contact of a round wire.

The various wires 28 of FIGS. 2A-2F with different cross-sectional shapes are configured to increase surface area contacts when formed into canted coil springs and used with connector components. By providing more surface-to-surface contacts with adjacent surfaces of the housing and the shaft over single point contacts typically found with round wires, the canted coil springs of the present disclosure can improve electrical conductivities, decrease resistance, and decrease heat buildup in the connectors. As readily understood, the wires disclosed herein each comprises a cross-section along a radial direction with a certain wire shape or configuration. In one embodiment, the cross-sectional configuration is symmetrical about an axis. For example, the elliptical shaped wire of FIG. 2C is symmetrical along at least one axis. In another embodiment, the cross-sectional shape is symmetrical about one axis but not another axis. For example, the wire of FIG. 2A has a line of symmetry and a line of non-symmetry. The wires are understood to have been modified along a radial cross-section by more than a few degrees associated with typically coiling or rolling the wires to make canted coil springs.

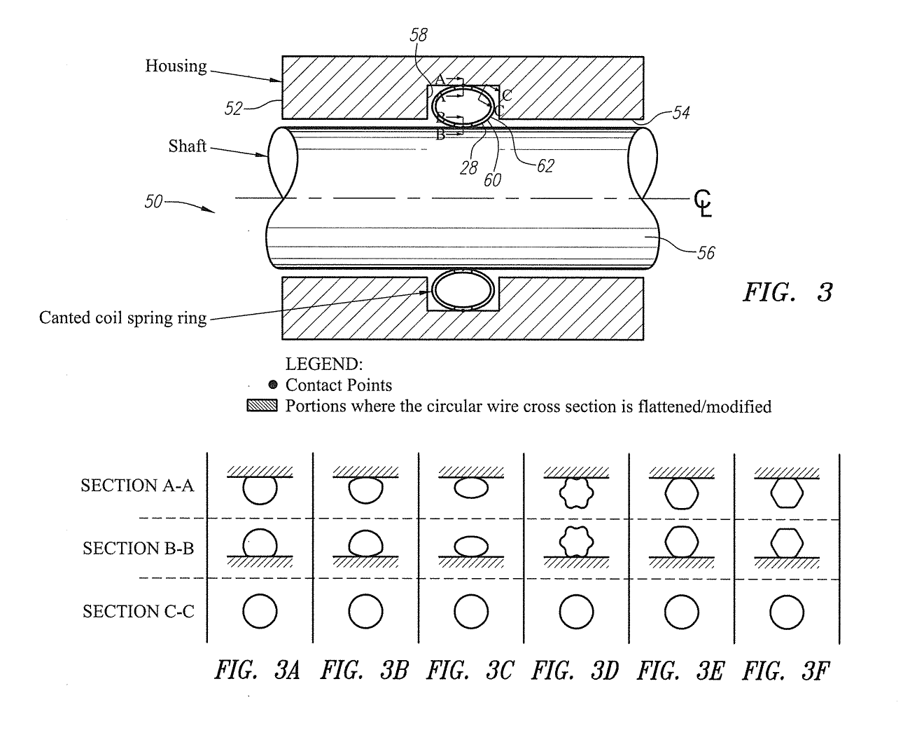

FIG. 3 is a partial cross-sectional side view of a connector 50 provided in accordance with aspects of the present disclosure. The connector 50 comprises a housing 52 having a bore 54 for receiving a shaft, rod, or pin 56. The connector 50 may be referred to as a holding connector in that only a single groove 58 is used to capture a canted coil spring 60, which has a plurality of spring coils 62. While the groove 58 is shown located in the housing, it could instead be incorporated on the shaft 58 and not in the housing. In other embodiments, the connector 50 is a latching and/or locking connector in that a second groove (not shown) is used to capture the spring. The groove 58 and the second groove (not shown) can embody various shapes to position the spring 60 in a certain orientation when captured by both grooves to either latch the spring, which permits separation, or to lock the spring within the both grooves, which does not permit disengagement without destroying the spring. Exemplary holding connectors and latching connectors are shown in U.S. Pat. Nos. 8,167,285 and 8,375,543, which are expressly incorporated herein by reference for purposes of disclosing possible grooved connectors that are usable with the canted coil springs of the present disclosure having shaped wires. The present canted coil springs having shaped wires are also useable with locking connectors disclosed in U.S. Pat. Nos. 5,082,390 and 5,411,348, which are expressly incorporated herein by reference. Locking connectors having two grooves, one in the housing and one on the shaft, for capturing a canted coil spring therebetween but does not permit separation of the pin from the housing of locking without deforming or destroying the spring.

As shown, the groove 58 has two generally parallel side walls and a flat bottom wall located therebetween. In other embodiments, the groove can have one or two tapered side walls in combination with a flat bottom wall or with a tapered bottom wall. When used in an electrical application, signal, current or electricity can travel from the housing 52 to the spring 60 and then to the shaft 56, or in the reverse direction. This allows two different electrical components, one connected to the housing and one connected to the pin, either directly or indirectly, to communicate with one another.

FIG. 3A shows three different end-views of the coil 62 of FIG. 3. In particular, FIG. 3A shows a wire 28 with a flat surface used to form the coil 62 and shows three different views taken along lines A-A, B-B, and C-C of FIG. 3. Note that section C-C of FIG. 3A shows the wire 28 having a different cross-section than that of sections A-A and B-B. This is understood to mean that the wire has sections that alternate between being round and being round with a flat surface 30, such as that shown in FIG. 2a. However, in some embodiments, the entire wire 28 used to form the canted coil spring 60 has a uniform shape resembling that of sections A-A and B-B of FIG. 3A.

FIG. 3B shows similar information as FIG. 3A except the wire 28 has a slightly curved section 40, which may be understood as a shaped wire or shaped section, similar to the wire 28 of FIG. 2B. In some embodiments, the entire wire 28 used to form the canted coil spring 60 has a uniform shape resembling that of sections A-A and B-B of FIG. 3B.

FIG. 3C shows similar information as FIG. 3A except the wire 28 is elliptical in shape 42, similar to the wire 28 of FIG. 2C. In some embodiments, the entire wire 28 used to form the canted coil spring 60 has a uniform shape resembling that of sections A-A and B-B of FIG. 3C.

FIG. 3D shows similar information as FIG. 3A except the wire 28 has a six-pointed star shape 44, similar to the wire 28 of FIG. 2D. In some embodiments, the entire wire 28 used to form the canted coil spring 60 has a uniform shape resembling that of sections A-A and B-B of FIG. 3D.

FIG. 3E shows similar information as FIG. 3A except the wire 28 has hexagonal shape 46 with rounded surfaces and rounded corners, similar to the wire 28 of FIG. 2E. In some embodiments, the entire wire 28 used to form the canted coil spring 60 has a uniform shape resembling that of sections A-A and B-B of FIG. 3E.

FIG. 3F shows similar information as FIG. 3A except the wire 28 has a hexagonal shape 48 with rounded corners, similar to the wire 28 of FIG. 2F. In some embodiments, the entire wire 28 used to form the canted coil spring 60 has a uniform shape resembling that of sections A-A and B-B of FIG. 3F.

Although the connector 50 shown for use with the springs of FIGS. 3A-3F is a holding connector comprising a single groove and wherein the spring is biased against a flat surface of the shaft 56, in other embodiments, the connector may be a latching connector, a locking connector, or a different holding connector shown in U.S. Pat. Nos. 8,167,285; 8,375,543; 5,082,390; and 5,411,348.

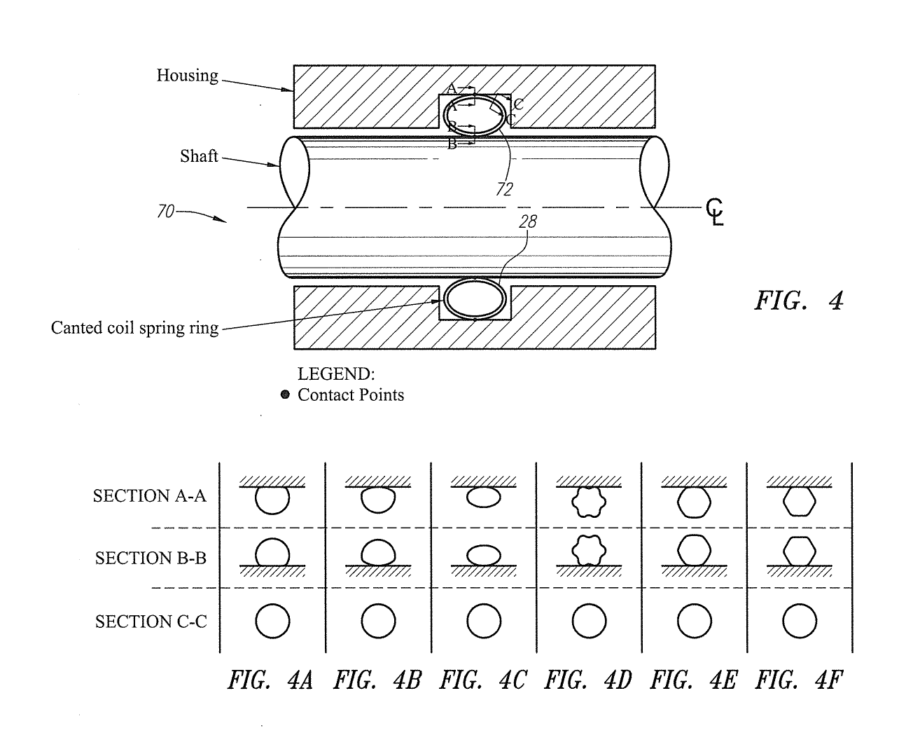

FIG. 4 shows a connector 70 that is similar to the connector 50 of FIG. 3 except the wire 28 used to form the spring 72 slightly differ, as discussed below with reference to FIGS. 4A-4F.

FIGS. 4A-4F show similar views as FIGS. 3A-3F. The difference being whereas FIGS. 3A-3F incorporate wires in which each has cross-sections that are generally round (viewing line C-C) with sections that have been modified or shaped (viewing lines A-A and B-B), FIGS. 4A-4F show wires that are generally the same throughout (viewing lines A-A, B-B, and C-C). In other words, the wires of FIGS. 4A-4F do not alternate but are generally uniform throughout the springs

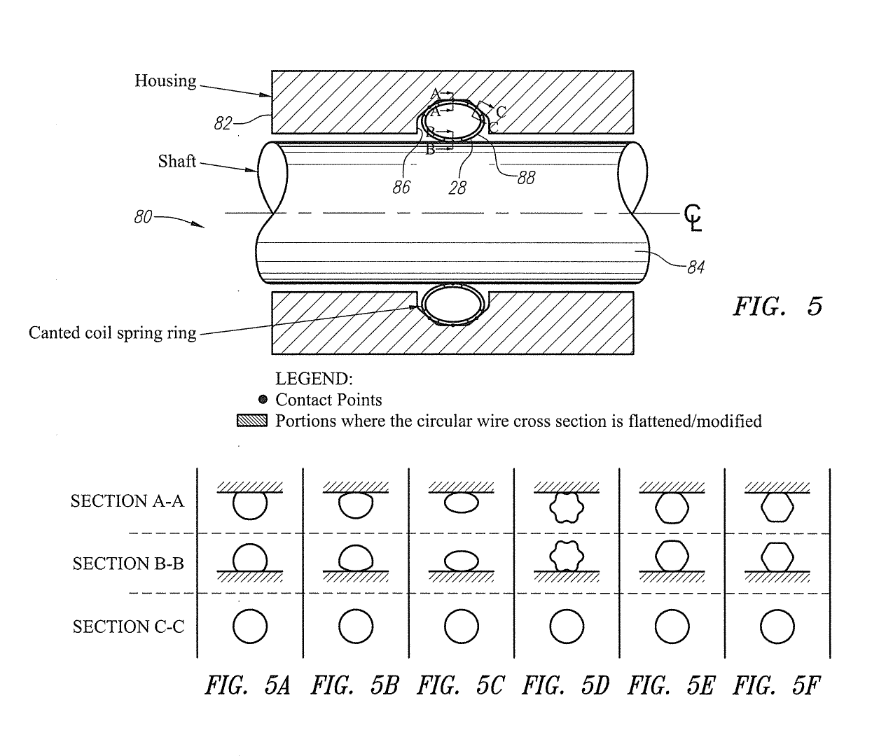

FIG. 5 is a partial cross-sectional side view of a connector 80 provided in accordance with aspects of the present disclosure, which includes assembly, system, and method for forming a shaped canted coil spring and using the shaped canted coil spring in a connector. The connector 80 comprises a housing 82 having a bore for receiving a shaft, rod, or pin 84. The connector 80 may be referred to as a holding connector in that only a single groove 86 is used to capture a canted coil spring 88, which has a plurality of spring coils. While the groove 86 is shown located in the housing 82, it could instead be incorporated on the shaft 84 and not in the housing. In other embodiments, the connector 80 is a latching and/or locking connector in that a second groove (not shown) is used to capture the spring.

As shown, the groove 86 has two generally parallel side walls and V-bottom, i.e., the groove is a V-groove. In other embodiments, the groove can have one or two tapered side walls in combination with a flat bottom wall or a tapered bottom wall. When used in an electrical application, signal, current or electricity can travel from the housing 82 to the spring 88 and then to the shaft 84, or in the reverse direction.

FIGS. 5A-5F show similar views as FIGS. 3A-3F. The difference being the location of where the generally round wire sections (line C-C) for the wires of FIGS. 3A-3F are located compared to the same sections (line A-A) for the wires of FIGS. 5A-5F. In the embodiments of FIGS. 5A-5F, the round wire sections A-A of each of the springs are located at the apex of the V-groove while the shaped sections are located at B-B and C-C and are in contact with the groove and the pin, respectively. The wires 28 for forming the springs of FIGS. 5A-5F therefore have sections that alternate between being round and being shaped with different contours.

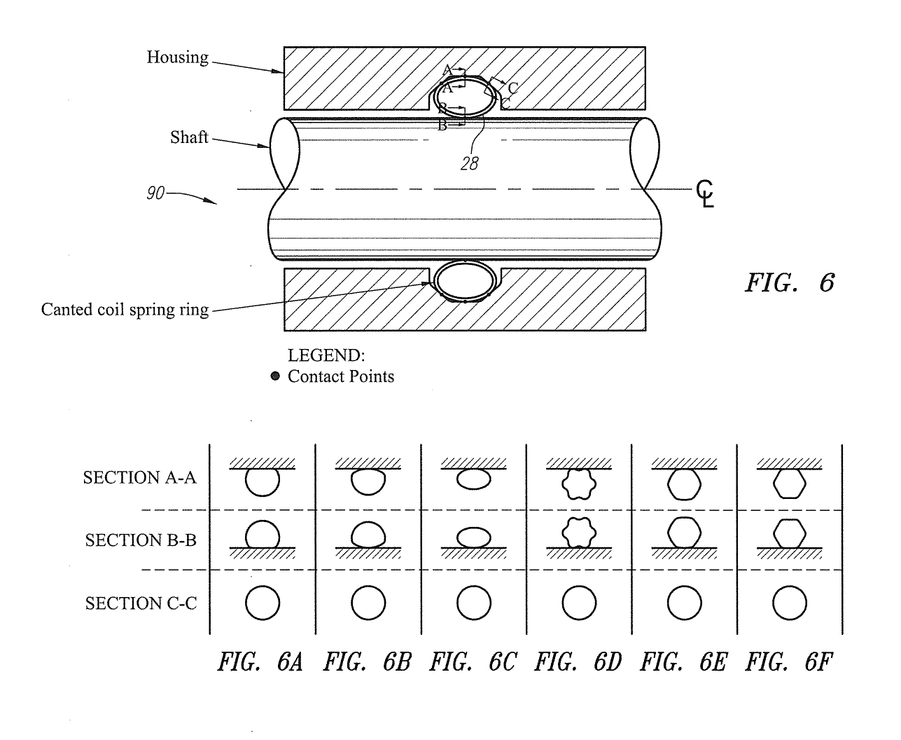

FIG. 6 shows a connector 90 that is similar to the connector 80 of FIG. 5 except the wire 28 used to form the spring slightly differ, as discussed below with reference to FIGS. 6A-6F.

FIGS. 6A-6F show similar views as FIGS. 4A-4F and incorporate similar wires. The difference being the location where each wire with modified or shaped cross-sections contacts the groove. The wires 28 for forming the springs of FIGS. 6A-6F therefore have sections that are generally uniform throughout the length of the springs.

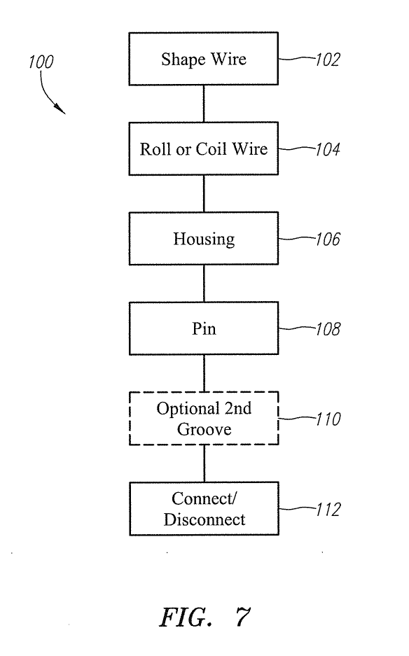

FIG. 7 shows a process or method 100 for forming a canted coil spring with a shaped wire, for forming a connector, and for using the canted coil spring with a shaped wire in a connector. At step 102, the process comprises shaping a round wire to form a length having all or at least some alternating sections of non-round wire sections. For example, the shaped section or sections can have a contour as shown in anyone of FIGS. 3A-3F and FIGS. 4A-4F. The wire can have alternating shaped sections or shaped contours along the length of the wire. The wire is then coiled or rolled to form a canted coil spring, which may be an axial canted coil spring or a radial canted coil spring in which a plurality of spring coils are canted along the same direction. The canted coil spring can have its two ends connected in a garter-type application for use with a pin or shaft or alternatively kept as a length having two free ends for use in a linear groove. In one example, a round wire is pushed through a die to form a shaped wire.

Steps 106-112 may be performed as independent or separate steps by another party or entity, separate from the spring forming steps. At step 106, the process includes forming a housing having a bore. At step 108, the process includes forming a pin having a tapered entrance or tapered end to facilitate insertion of the pin into the bore of the housing. The housing or the pin or both can incorporate a groove. If only one groove is provided, the application is a holding application. If two grooves are provided, such as at step 110, to form a common groove for capturing the spring therebetween, then the application is a latching or a locking application.

At step 112, the process comprises placing the spring into the groove. If the spring is placed into the groove of the housing, then the spring is housing mounted and if the spring is placed into the pin groove, then the spring is pin mounted. The process further includes inserting the pin into the bore of the housing to hold, latch, or lock the pin the housing together.

Although limited embodiments of the canted coil springs and connectors and their components have been specifically described and illustrated herein, many modifications and variations will be apparent to those skilled in the art. For example, the various grooves may be modified to have different geometries, the materials selected for the housing, the shaft, and the spring can differ, and multiple grooves and combination of grooves may be incorporated, etc. Furthermore, it is understood and contemplated that features specifically discussed for one spring and/or connector embodiment may be adopted for inclusion with another connector embodiment, provided the functions are compatible. For example, while the various cross-sectional wires are discussed, wires with many other shapes and geometries may be used to form the disclosed canted coil springs, including various polygonal shapes, and various complex shapes with increased contact surface areas. Additionally, the springs and/or the connectors discussed herein may be used in a number of different applications and industries, such as for automotive, power transmission, for oil and gas, for aerospace, for consumer electronics, etc. Further, the wires used to form the springs described herein may be made from a single uniform wire or from a multi-metallic wire in which the wire has a core of a first metallic material and an outer cladding of a second metallic material with optional third or fourth layers of yet different metallic materials. Accordingly, it is to be understood that the springs and connectors and their components constructed according to principles of the disclosed devices, systems, and methods may be embodied in other than as specifically described herein. The disclosure is also defined in the following claims.

What is claimed is:

1. A method for manufacturing a spring comprising:
obtaining a wire that has at least a wire cross-section with a different shape than a generally round shape; and
coiling the wire to form a plurality of interconnected coils with each coil canting in a same direction relative to a coil axis.

2. The method of claim 1, wherein the wire has been drawn through a die to have the different shape wire cross-section.

3. The method of claim 1, wherein the different shape wire cross-section is a round shape with a flat section, a round shape with a partially flatted section, an elliptical shape, a multi-point star shape, a hexagonal shape with round corners and rounded sides, a hexagonal shape with rounded corners, or combinations thereof.

4. The method of claim 1, wherein the spring is an axial canted coil spring or a radial canted coil spring.

5. The method of claim 1, wherein the different shape is located on a first side edge and a second side edge of the spring.

6. The method of claim 1, wherein the wire has the different shape along an entire length of the wire.

7. The method of claim 1, further comprising placing the spring into a groove comprising two sidewalls and a bottom wall and wherein the different shape contacts the sidewalls or the bottom wall.

8. The method of claim 1, wherein the bottom wall is V-shape.

9. The method of claim 7, wherein the groove is located in a bore of a housing or an outside surface of a shaft.

10. A connector comprising a housing and a shaft, a groove associated with the housing, the shaft, or both and having a canted coil spring disposed therein, wherein the spring comprises at least a wire cross-section with a different shape than a generally round shape cross-section at locations of the spring that contact the housing, the shaft, or both the housing and the shaft.

11. The connector of claim 10, wherein the wire cross-section with the different shape is a round shape with a flat section, a round shape with a partially flatted section, an elliptical shape, a multi-point star shape, a hexagonal shape with round corners and rounded sides, a hexagonal shape with rounded corners, or combinations thereof.

12. The connector of claim 10, wherein the groove is located in a bore of the housing.

13. The connector of claim 10, wherein the wire for forming the spring is made entirely from the different shape wire cross-section than round.

14. The connector of claim 10, wherein the groove is located on an outside of the shaft.

15. The connector of claim 10, wherein spring is made from a multi-metallic wire.

16. The connector of claim 10, wherein the groove is associated with both the housing and the shaft and the connector of a latching connector or a locking connector.

17. The connector of claim 10, wherein the groove has a flat bottom or a V-bottom groove.

18. A canted coil spring comprising a plurality of coils all canted along a same direction and wherein the spring is made from a wire having at least a wire cross-section with a different shape than a generally round shape wire cross-section.

19. The canted coil spring of claim 18, wherein the spring is a garter-type radial canted coil spring or axial canted coil spring.

20. The canted coil spring of claim 18, wherein with the different shape cross-section is a round shape with a flat section, a round shape with a partially flatted section, an elliptical shape, a multi-point star shape, a hexagonal shape with round corners and rounded sides, a hexagonal shape with rounded corners, or combinations thereof.
